(19) United States
(12) Patent Application Publication
(10) Pub. No.: US 2008/0227009 A1
(43) Pub. Date: Sep. 18, 2008

(54) DEVELOPING DEVICE AND IMAGE FORMING METHOD USING ONE COMPONENT DEVELOPER, AND PROCESS CARTRIDGE USING THE DEVELOPING DEVICE

(76) Inventors: Kazuoki FUWA, Toyonaka-shi (JP); Masayuki HAGI, Minoo-shi (JP); Yoshihiro MIKURIYA, Nishinomiya-shi (JP); Hideaki YASUNAGA, Ibaraki-shi (JP); Hiroaki KATOH, Nagaokakyo-shi (JP); Yoshitaka SEKIGUCHI, Nishinomiya-shi (JP); Satoshi OGAWA, Nara-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/027,704

(22) Filed: Feb. 7, 2008

(30) Foreign Application Priority Data
Mar. 15, 2007 (JP) 2007-067649

(51) Int. Cl. G03G 13/06; G03G 15/08

(52) U.S. Cl. 430/97; 399/286

(57) ABSTRACT

A developing device including a developing roller and a developer layer forming member for forming a layer of a one component developer on the roller. The developing device satisfies the relationships (1) 20<X<65−14α, and (2) 12.7α−25>Q/M>13.1α−44.5, wherein X represents the ratio (% by weight) of the wax present on the surface of the developer to the total of the wax therein; α represents the angle formed by a tangent line to the member at a point B, which is the center of the contact zone of the member contacted with the roller, and another tangent line at a point A thereof 0.5 mm apart from the point B toward the tip of the member, wherein α is 0 to π/2 radian; and Q/M represents the charge quantity (μC/g) of the toner per unit weight.

### BACKGROUND OF THE INVENTION

1. Field of the Invention

The present invention relates to a developing device using a one component developer. In addition, the present invention also relates to an image forming method using a one component developer and a process cartridge using the developing device.

2. Discussion of the Background

Recently, a need exists for small-sized and low-cost laser printers for use in a low-end market. It is essential to use a fixing device (particularly a heat roller fixing device) without an oil applicator for small-sized printers. However, heat roller fixing devices often cause an offset problem in that part of a toner image formed on a sheet of a receiving material is transferred to a fixing member of the fixing devices, and the transferred toner image is retransferred to the receiving material sheet and/or the next receiving material sheet, resulting in formation of abnormal images. In order to prevent occurrence of the offset problem, toners including a wax as a release agent are typically used. However, such toners have an increased adherence.

On the other hand, one component developing devices such that a developer layer forming blade is set so as to be opposed to the developing roller to form a developer layer having a predetermined thickness on the surface of the developing roller while frictionally charging the developer are typically used. In this regard, when the angle (i.e., the angle (α) illustrated in FIG. 2) formed by a tangent angle to a point A of the developer layer forming blade and the surface of the developing roller (i.e., the tangent line at a point B) is too high, the stress applied to the toner increases although the amount of the toner passing through the nip between the developer layer forming blade and the surface of the developing roller. In this case, the exposed wax present on the surface of the toner particles tends to release (or exude) from the toner particles, and the released wax is then adhered to the developer layer forming blade. In addition, toner particles are also adhered to the wax on the developer layer forming blade, resulting in occurrence of a problem in that a developer layer having a predetermined thickness and a predetermined charge cannot be formed.

In contrast, when the angle (α) is too low, the amount of the toner particles passing through the nip increases due to the pressure of the toner, and thereby the toner particles cannot be well charged, resulting in occurrence of a background development problem in that the background of images is soiled with the toner particles.

In attempting to solve the wax adhesion problem, published unexamined Japanese patent application No. 2006-243301 discloses a technique such that the amount of the wax present on the surface of a toner and the amount of the wax included inside the toner are specified, and further the pressure at the nip between the developer layer forming blade and the developing roller is also specified. However, since the developer layer forming blade is not controlled, the technique cannot definitely settle the wax adhesion problem.

Because of these reasons, a need exists for a developing device, which can produce high quality toner images without causing the wax adhesion problem and the background development problem.

### SUMMARY OF THE INVENTION

As an aspect of the present invention, a developing device is provided which includes at least a developing roller configured to bear a one component developer (i.e., a toner) thereon, and a developer layer forming member configured to form a developer layer on the surface of the developing roller. The one component developer includes at least a binder resin, a wax and a colorant, and the developing device satisfies the following relationships (1) and (2):

20<X<65−14α (1), and

12.7α−25>Q/M>13.1α−44.5 (2),

wherein X represents the ratio (i.e., exposed wax ratio) in units of % by weight of the wax present on a surface of the developer (i.e., the exposed wax) to the total of the wax included in the developer; α represents an angle formed by a first tangent line to the developer layer forming member at a point B, which is the center of the contact zone (i.e., the nip) of the developer layer forming member contacted with the surface of the developing roller, and a second tangent line to the developer layer forming member at a point A thereof, which is 0.5 mm apart from the point B toward the tip of the developer layer forming member, wherein the angle α is from 0 to π/2 radian; and Q/M represents the charge quantity of the toner per unit weight and has units of μC/g.

As another aspect of the present invention, a process cartridge is provided which includes at least an image bearing member (such as photoreceptors) configured to bear an electrostatic image thereon and the above-mentioned developing device configured to develop the electrostatic image to form a toner image on the image bearing member. The process cartridge is detachably attached to an image forming apparatus as a unit.

As a yet another aspect of the present invention, an image forming method is provided which includes:

forming a layer of a one component developer on a developing roller using a developer layer forming blade; and

developing an electrostatic image on an image bearing member with the developer layer on the developing roller,

wherein the above-mentioned relationships (1) and (2) are satisfied.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view illustrating an example of the process cartridge of the present invention including an example of the developing device of the present invention; and

FIG. 2 is a schematic view for explaining the angle (α)

### DETAILED DESCRIPTION OF THE INVENTION

The developing device of the present invention includes at least a developing roller configured to bear a one component developer thereon, and a developer layer forming member configured to form a developer layer on the surface of the developing roller. The one component developer (i.e., the toner) includes at least a binder resin, a wax and a colorant, and the developing device satisfies the following relationships (1) and (2):

20<X<65−14α (1), and

12.7α−25>Q/M>13.1α−44.5 (2),

wherein X represents the exposed wax ratio (in units of % by weight) of the exposed wax present on the surface of the toner to the total of the wax included in the toner; α represents the angle (in units of radian) formed by a first tangent line to the developer layer forming member at a point B, which is the center of the contact zone (i.e., nip) of the developer layer forming member contacted with the surface of the developing roller, and a second tangent line to the developer layer forming member at a point A thereof, which is 0.5 mm apart from the point B toward the tip of the developer layer forming member, wherein the angle α is from 0 to π/2 radian; and Q/M represents the charge quantity of the toner per unit weight and has units of μC/g.

In this regard, the developer layer forming member is made of a metal and has a V-form (i.e., an elementary portion and a tip portion).

When X (i.e., the ratio of the wax present on the surface of the toner to the total of the wax included in the toner, hereinafter referred to as the exposed wax ratio) is not greater than 20%, an insufficient amount of wax tends to be exuded from the toner in the fixing process, resulting in occurrence of the offset problem. When the exposed wax ratio X is not less than 65−14α, the toner tends to be adhered to the developer layer forming member, resulting in occurrence of the wax adhesion problem.

When the charge quantity Q/M is not less than 12.7α−25, a proper amount of developer cannot be attracted by the developing roller and thereby the background development problem is easily caused. In contrast, when the charge quantity Q/M is not greater than 13.1α−44.5, the developer layer on the developing roller is strongly attracted by the developing roller, and thereby an abnormal image (i.e., a ghost image) such that the same image is repeatedly formed on one or more sheets of a receiving material at regular intervals equal to the peripheral length of the developing roller tends to be formed on an image.

The pressure (linear pressure) at the nip between the developer layer forming member and the developing roller is preferably from 20 N/m to 60 N/m. When the pressure is too low, the amount of the developer in the developer layer on the developing roller excessively increases. In this case, the developer cannot be sufficiently charged, and thereby the background development problem is caused. In contrast, when the pressure is too high, the stress applied to the developer seriously increases, and therefore the wax adhesion problem is easily caused.

The toner serving as the one component developer preferably has a volume average particle diameter of from 6 μm to 10 μm. When the volume average particle diameter of the toner is too small, the adhesiveness of the toner particles seriously increases and thereby a toner adhesion problem in that the toner is adhered to the developer layer forming member is easily caused. When the volume average particle diameter is too large, images with good resolution cannot be produced.

The toner preferably has a differential scanning calorimetry (DSC) curve in a temperature range of from 30 to 200° C. such that a maximum endothermic peak is observed at a temperature range of from 65 to 95° C. When the endothermic peak is observed at a temperature lower than 65° C., the wax tends to easily exude from the toner, thereby causing the wax adhesion problem. In contrast, when the endothermic peak is observed at a temperature higher than 95° C., toner images cannot be easily released from fixing members, and thereby the offset problem is easily caused.

The toner preferably includes an external additive in an amount of from 2.5 to 5.0% by weight based on the total weight of the toner. When the amount of the external additive included in the toner is too small, the adhesiveness of the toner increases, and thereby the toner adhesion problem is easily caused. In contrast, when the amount of the external additive is too large, the external additive is easily released from the toner particles, resulting in formation of abnormal images.

The toner (i.e., the one-component developer) for use in the developing device of the present invention typically includes toner particles and an external additive. The toner particles typically include a binder resin, a wax and a colorant, and optionally include other additives such as charge controlling agents. The toner particles can be prepared by, for example, a method including the following steps:
(1) dispersing a colorant and a wax (and optional additives) in a thermoplastic resin serving as a binder resin upon application of heat thereto to melt the binder resin;
(2) cooling the dispersed mixture;
(3) pulverizing the cooled mixture; and
(4) classifying the pulverized mixture to prepare the toner particles.

Next, the constituents of the toner serving as the one-component developer will be explained in detail.

### Binder Resin

The binder resin included in the toner for use in the developing device of the present invention is not particularly limited, and any known binder resins which can be used for conventional full color toners can be used. Specific examples thereof include polyester resins, (meth)acrylic resins, styrene-(meth)acrylic copolymers, epoxy resins, cyclic olefin resins (e.g., TOPAS-COC (from Ticona)), etc. Among these resins, polyester resins are preferably used because of having good resistance to stresses applied to the toner in the developing device.

Suitable polyester resins for use in the toner include polyester resins which are prepared by subjecting a polyhydric alcohol and a polycarboxylic acid to a polycondensation reaction. Specific examples of the dihydric alcohols for use as the polyhydric alcohol include alkylene oxide adducts of bisphenol A such as polyoxypropylene(2.2)-2,2-bis(4-hydroxyphenyl)propane, polyoxypropylene(3.3)-2,2-bis(4-hydroxyphenyl)propane, polyoxypropylene(6)-2,2-bis(4-hydroxyphenyl)propane, and polyoxypropylene(2.0)-2,2-bis(4-hydroxyphenyl)propane; ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polytetramethylene glycol, bisphenol A, hydrogenated bisphenol A, etc. Specific examples of the tri- or more hydric alcohols for use as the polyhydric alcohol include sorbitol, 1,2,3,6-hexanetetrol, 1,4-sorbitane, pentaerythritol, dipentaerythritol, tripentaerythritol, 1,2,4-butanetriol, 1,2,5-pentanetriol, glycerol, 2-methylpropanetriol, 2-methyll,2,4-butanetriol, trimethylol ethane, trimethylol propane, 1,3,5-trihydroxymethyl benzene, etc.

Specific examples of the dicarboxylic acids for use as the polycarboxylic acid include maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, n-dodecenylsuccinic acid, iso-dodecenylsuccinic acid, n-octenylsuccinic acid, iso-octenylsuccinic acid, n-octylsuccinic acid, iso-octylsuccinic acid, anhydrides or low alkyl esters of these acids, etc.

Specific examples of the tri- or more carboxylic acids for use as the polycarboxylic acid include 1,2,4-benzenetricarboxylic acid (trimellitic acid), 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxy-2-methyl-2-methylenecarboxypropane, 1,2,4-cyclohexanetricarboxylic acid, tetra(methylenecarboxy)methane, 1,2,7,8-octanetetracarboxylic acid, pyromellitic acid, trimer acids of embole, anhydrides or low alkyl esters of these acids, etc.

In addition, vinyl-polyester resins, which are prepared by mixing monomers of a polyester resin, one or more monomers of a vinyl resin, and one or more monomers which are reactive with both the monomers of the polyester resin and the monomers of the vinyl resin, and subjecting the monomers to a polycondensation reaction (to prepare the polyester resin) and a radical polymerization reaction (to prepare the vinyl resin) at the same time, can also be used as a polyester resin. The monomers which are reactive with both the monomers of the polyester resin and the monomers of the vinyl resin are monomers which can be used for both a polycondensation reaction and a radical polymerization reaction, i.e., monomers which have both a carboxyl group which can cause a polycondensation reaction and a vinyl group which can cause a radical polymerization reaction. Specific examples of such monomers include fumaric acid, maleic acid, acrylic acid, methacrylic acid, etc.

Specific examples of the monomers for use in preparing the polyester component of such vinyl-polyester resins include the polyhydric alcohols and polycarboxylic acids mentioned above. Specific examples of the monomers for use in preparing the vinyl resin component of the vinyl-polyester resins include styrene and derivatives thereof such as styrene, o-methylstyrene, m-methylstyrene, p-methylstyrene, α-methylstyrene, p-ethylstyrene, 2,4-dimethylstyrene, p-tert-butylstyrene, and p-chlorostyrene; ethylene-type unsaturated mono-olefins such as ethylene, propylene, butylene, and isobutylene; alkyl esters of methacrylic acid such as methyl methacrylate, n-propyl methacrylate, isopropyl methacrylate, n-butyl methacrylate, isobutyl methacrylate, t-butyl methacrylate, n-pentyl methacrylate, isopentyl methacrylate, neopentyl methacrylate, 3-(methyl)butyl methacrylate, hexyl methacrylate, octyl methacrylate, nonyl methacrylate, decyl methacrylate, undecyl methacrylate, and dodecyl methacrylate; alkyl esters of acrylic acid such as methyl acrylate, n-propyl acrylate, isopropyl acrylate, n-butyl acrylate, isobutyl acrylate, t-butyl acrylate, n-pentyl acrylate, isopentyl acrylate, neopentyl acrylate, 3-(methyl)butyl acrylate, hexyl acrylate, octyl acrylate, nonyl acrylate, decyl acrylate, undecyl acrylate, and dodecyl acrylate; unsaturated carboxylic acids such as acrylic acid, methacrylic acid, itaconic acid, and maleic acid; acrylonitrile, esters of maleic acid, esters of itaconic acid, vinyl chloride, vinyl acetate, vinyl benzoate, vinyl methyl ketone, vinyl ethyl ketone, vinyl hexyl ketone, vinyl methyl ether, vinyl ethyl ether, and vinyl isobutyl ether.

Specific examples of the polymerization initiators for use in polymerizing the vinyl monomers include azo-type or diazo-type initiators such as 2,2′-azobis(2,4-dimethylvaleronitrile), 2,2′-azobisisobutylonitirile, 1,1′-azobis(cyclohexane-1-carbonitrile), and 2,2′-azobis-4-methoxy-2,4-dimethylvaleronitrile; and peroxide-type initiators such as benzoyl peroxide, dicumyl peroxide, methyl ethyl ketone peroxide, isopropyl peroxy carbonate, and lauroyl peroxide.

The above-mentioned polyester resins are preferably used as the binder resin of the toner of the present invention. In order that the toner can be used for oil-less fixing methods, the toner preferably has a good combination of releasability and offset resistance. In order to impart a good combination of releasability and offset resistance to the toner, a combination of a first binder resin and a second binder resin is preferably used for the binder resin. Suitable resins for use as the first binder resin include polyester resins which are prepared by subjecting a polyhydric alcohol and a polycarboxylic acid to a polycondensation reaction, and preferably polyester resins which are prepared by subjecting an alkylene oxide adduct of bisphenol A (serving as a polyhydric alcohol) and terephthalic acid or fumaric acid (serving as a polycarboxylic acid) to a polycondensation reaction. Suitable resins for use as the second binder resin include vinyl-polyester resins, and preferably vinyl-polyester resins which are prepared by using an alkylene oxide adduct of bisphenol A, terephthalic acid, trimellitic acid and succinic acid as the monomers for forming a polyester resin component; styrene and butyl acrylate as the monomers for forming a vinyl resin component; and fumaric acid as the monomer for use in both the polycondensation reaction and radical polymerization reaction.

When the first binder resin is synthesized, it is preferable to internally add a hydrocarbon wax to the resin. A hydrocarbon wax can be internally added to the first binder resin by polymerizing a mixture of monomers for constituting the first binder resin and the hydrocarbon wax. Specifically, a mixture of an acid monomer, an alcohol monomer and a hydrocarbon wax is subjected to a polycondensation reaction. When the first binder resin is a vinyl-polyester resin, the following method is preferably used:
(1) a mixture of monomers for constituting a polyester resin component and a hydrocarbon wax is heated while agitated to perform a polycondensation reaction; and
(2) one or more monomers for constituting a vinyl resin component are dropped into the mixture to perform a radical polymerization reaction.

The weight ratio (b1/b2) of the first binder resin (b1) (including a wax) to the second binder resin (b2) is preferably from 20/80 to 45/55, and more preferably from 30/70 to 40/60. When the content of the first binder resin is too low, the releasability and hot offset resistance of the toner deteriorate. In contrast, when the content is too high, the glossiness of images and high temperature preservability of the toner deteriorate.

The binder resin of the toner of the present invention, which preferably includes a first binder resin (including a wax) and a second binder resin, preferably has a softening point of from 100 to 125° C., and more preferably from 105 to 125° C.

The first binder resin including a wax preferably has an acid value of from 5 to 50 mgKOH/g, and more preferably from 10 to 40 mgKOH/g. The second binder resin preferably has an acid value of from 0 to 10 mgKOH/g, and more preferably from 1 to 5 mgKOH/g. Particularly, when polyester resins having such an acid value are used, a colorant can be well dispersed in toner particles and in addition the resultant toner has a sufficient amount of charge. The first binder resin preferably includes a component insoluble to tetrahydrofuran (THF) to impart good hot offset resistance to the toner. The first binder resin including a wax preferably includes THF-insoluble components in an amount of from 0.1 to 15% by weight, preferably from 0.2 to 10% by weight, and more preferably from 0.3 to 5% by weight.

### Wax

In general, waxes having a low polarity have good releasability from fixing members (such as fixing rollers). Therefore, hydrocarbon waxes having a low polarity are preferably used for the toner of the present invention. Hydrocarbon waxes mean waxes constituted of carbon atoms and hydrogen atoms, which do not include a group such as ester groups, alcohol groups and amide groups. Specific examples of the hydrocarbon waxes include polyolefin waxes such as polyethylene, polypropylene, and ethylene-propylene copolymers; petroleum waxes such as paraffin waxes and microcrystalline waxes; synthetic waxes such as FISCHER TROPSCH WAXES; etc. Among these hydrocarbon waxes, polyethylene waxes, paraffin waxes, and FISCHER TROPSCH WAXES are preferably used, and polyethylene waxes and paraffin waxes are more preferably used.

The wax used for the toner of the present invention preferably has a melting point of from 70 to 90° C., which is defined as the temperature at which an endothermic peak is observed in a temperature rising process of differential scanning calorimetry (DSC). When the melting point is too high, the wax is insufficiently melted at the fixing process and thereby releasability of the toner is deteriorated. When the melting point is too low, a preservation problem in that particles of the toner aggregate under high temperature and high humidity conditions is caused. The melting point is more preferably from 70 to 85° C. and even more preferably from 70 to 80° C. such that the resultant toner images can be fixed with a good margin even under low temperature conditions.

The half width of the endothermic peak of the wax observed in differential scanning calorimetry is preferably not greater than 7° C. When the endothermic peak of the wax is broad, the high temperature preservability of the toner deteriorates because the wax melts at a relatively low temperature.

The toner preferably includes a wax in an amount of from 2.5 to 4.0% by weight based on the total weight of the toner.

### Colorant

Known pigments and dyes for use in conventional color toners can be used as the colorant of the toner for use in the developing device of the present invention. Specific examples of the pigments and dyes include carbon black, Aniline Blue, chalco-oil blue, chrome yellow, ultramarine blue, DUPONT OIL RED, Ouinoline Yellow, Methylene Blue chloride, Copper Phthalocyanine, Malachite Green oxalate, lamp black, Rose Bengale, C.I. Pigment Red 48:1, C.I. Pigment Red 122, C.I. Pigment Red 57:1, C.I. Pigment Red 184, C.I. Pigment Yellow 97, C.I. Pigment Yellow 12, C.I. Pigment Yellow 17, C.I. Pigment Yellow 74, C.I. Solvent Yellow 162, C.I. Pigment Yellow 180, C.I. Pigment Yellow 185, C.I. Pigment Blue 15:1, C.I. Pigment Blue 15:3, etc.

The content of the colorant in the toner is preferably 2 to 15 parts by weight based on 100 parts by weight of the total weight of the binder resin. The colorant is preferably used in a form of master batch, which is prepared by dispersing a pigment in a mixture of the first binder resin and the second binder resin. The content of a colorant in a master batch is preferably from 20 to 40% by weight based on the total weight of the master batch. The added amount of the master batch is preferably controlled such that the content of the colorant in the toner falls in the above-mentioned range.

### Charge Controlling Agent

Known charge controlling agents for use in conventional toners can be used for the toner for use in the present invention.

Specific examples of the charge controlling agents include Nigrosine dyes, triphenyl methane dyes, chromium-containing metal complex dyes, molybdic acid chelate pigments, Rhodamine dyes, alkoxyamines, quaternary ammonium salts, fluorine-modified quaternary ammonium salts, alkylamides, phosphor and its compounds, tungsten and its compounds, fluorine-containing activators, metal salts of salicylic acid, metal salts of salicylic acid derivatives, etc. These materials can be used alone or in combination.

Specific examples of the marketed charge controlling agents include BONTRON 03 (Nigrosine dye), BONTRON P-51 (quaternary ammonium salt), BONTRON S-34 (metal-containing azo dye), BONTRON E-82 (metal complex of oxynaphthoic acid), BONTRON E-84 (metal complex of salicylic acid), and BONTRON E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative), COPY CHARGE NEG VP2036 and COPY CHARGE NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments, and polymers having a functional group such as a sulfonic acid group, a carboxyl group, a quaternary ammonium group, etc.

Among these materials, materials which can impart negative charges to the toner are preferably used.

The content of the charge controlling agent in the toner is determined depending on the variables such as choice of binder resin, presence of additives, and dispersion method. In general, the content of the charge controlling agent is preferably from 0.1 to 10 parts by weight, and more preferably from 0.2 to 5 parts by weight, per 100 parts by weight of the binder resin included in the toner. When the content is too high, the toner has an excessive amount of charge, and thereby the electrostatic attraction between the developing roller and the toner is seriously increased, resulting in deterioration of fluidity and decrease of image density.

### External Additive

The toner for use in the developing device of the present invention preferably includes a particulate inorganic material as an external additive to improve the fluidity and developing property thereof. Specific examples of the inorganic material include silicon oxide, zinc oxide, tin oxide, silica sand, titanium oxide, clay, mica, wollastonite, diatomearth, chromium oxide, cerium oxide, red iron oxide, antimony oxide, magnesium oxide, zirconium oxide, barium oxide, barium carbonate, calcium carbonate, silicon carbide, silicon nitride, etc.

### Method for Preparing the Toner

The toner for use in the present invention is typically prepared by the following method, but the preparation method is not limited thereto.
(1) A first binder including a hydrocarbon wax, a second binder and a colorant are mixed and kneaded upon application of heat thereto;
(2) after the kneaded mixture is cooled, the mixture is pulverized and the resultant powder is classified to prepare a colored particulate material (i.e., toner particles); and
(3) an external additive is mixed with the toner particles, resulting in formation of the toner for use in the present invention.

Next, the developing device and process cartridge of the present invention will be explained by reference to drawings.

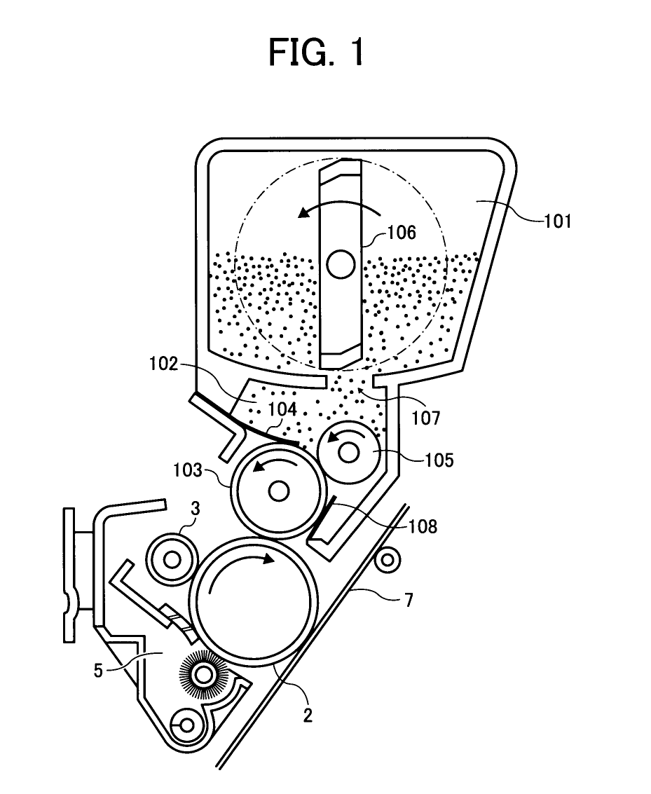

FIG. 1 is a schematic view illustrating the cross section of an example of the developing device and process cartridge of the present invention.

The developing device includes a developer containing room 101 containing the above-mentioned toner serving as a one component developer and a developer supplying room 102, which is located below the developer containing room 101 and which supplies the developer. Below the developer supplying room 102, a developing roller 103, a developer layer forming member 104, which is contacted with the surface of the developing roller 103, and a developer supplying roller 105 are arranged. The developing roller 103 is set so as to contact a photoreceptor drum 2, and a predetermined developing bias is applied thereto by a high voltage power source (not shown).

In the developer containing room 101, a developer agitator 106, which is counterclockwise rotated, is provided. The developer agitator 106 has a rotating blade extending in the longitudinal direction (i.e., the axial direction) of the agitator and having a configuration such that the tip portions of the blade have a large surface area except for the tip portions which pass near an opening 107 of the developer containing room 101 to well agitate the developer in the developer containing room 101. Namely, the tip portions of the blade which pass near the opening 107 have a smaller surface area so as not to feed an excess amount of developer through the opening 107.

The developer near the opening 107 is agitated by the blade of the developer agitator 106 so as not to form aggregated particles, and falls due to its weight to the developer supplying room 102 through the opening 107. The surface of the developer supplying roller 105 is made of a foamed material having cells so that the developer supplying roller 105 can well bear the developer thereon and in addition the pressure applied to the developer on the developer supplying roller 105 is decreased to prevent deterioration of the developer.

The foamed material used for the surface of the developer supplying roller 105 preferably has a resistance of from 103 to 10¹⁴Ω. A bias is applied to the developer supplying roller 105. Specifically, by applying the bias to the developer supplying roller 105, the developer, which is present on the developer supplying roller 105 and which has been preliminarily charged at a nip between the developer supplying roller 105 and the developing roller 103, is forwarded toward the developing roller 103. The polarity of the bias applied to the developer supplying roller 105 is not particularly limited, and the polarity may be the same as or opposite to that of the charge of the developer. Alternatively, it is possible not to apply a bias to the developer supplying roller 105.

The developer supplying roller 105 is counterclockwise rotated like the developing roller 103 and supplies the toner thereon to the surface of the developing roller 103. The developing roller 103 has an elastic rubber layer, and an outermost layer which is located on the elastic rubber layer and which is made of a material which can be easily charged so as to have a charge with a polarity opposite to that of the charged developer. The elastic rubber layer preferably has a JIS-A hardness of not greater than 50 degree so that the developing roller 103 can be evenly contacted with the photoreceptor drum 2. In addition, the elastic rubber layer preferably has an electric resistance of from 10³ to 10¹⁰Ω so that the developing bias can be efficiently applied thereto.

The surface of the developing roller 103 preferably has an Arithmetical Mean Deviation of the Profile (Ra) of from 0.2 to 2.0 μm so that a proper amount of developer is borne on the surface of the developing roller 103.

The developing roller 103 is counterclockwise rotated to feed the developer thereon to the developer layer forming member 104 and the nip between the developing roller 103 and the photoreceptor drum 2.

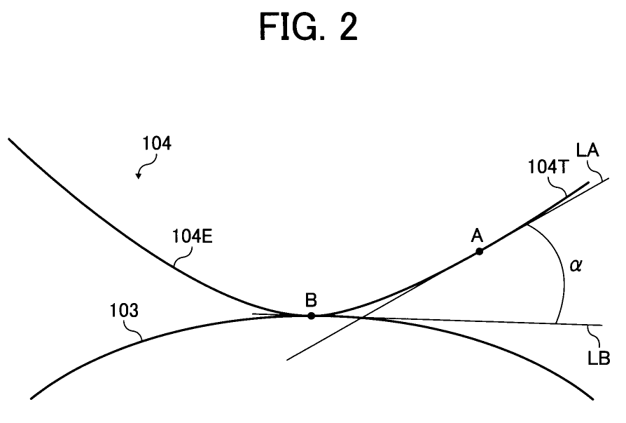

The developer layer forming member 104 is a plate spring made of a metal such as SUS304CSP, SUS301CSP, and phosphor bronze. As illustrated in FIG. 2, the tip portion near the free end portion of the developer layer forming member 104 is contacted with the surface of the developing roller 103, wherein the linear pressure applied to the member 104 is from 10 to 100 N/m. The particles of the developer passing through the nip between the developer layer forming member 104 and the developing roller 103 form a thin developer layer while being frictionally charged by the developer layer forming member 104. In addition, a bias, whose polarity is the same as that of the charge of the developer, may be applied to the developer layer forming member 104 to

The photoreceptor drum 2 is clockwise rotated. Therefore, the photoreceptor drum 2 and the developing roller 103 move in the same direction at the nip therebetween. The thin developer layer formed on the surface of the developing roller 103 is fed to the nip due to the rotation of the developing roller 103. The particles of developer on the surface of the developing roller 103 are moved to an electrostatic latent image formed on the surface of the photoreceptor drum 2 by the electric field formed by the electrostatic latent image and the developing bias applied to the developing roller 103, resulting in formation of a toner image on the surface of the photoreceptor drum 2. The particles of the developer remaining on the surface of the developing roller 103 without being used for developing the electrostatic latent image is returned to the developer supplying room 102. A seal 108 is provided along the surface of the developing roller 103 so that the developer in the developer supplying room 102 does not leak from the developing device.

In FIG. 1, a charging member charges the photoreceptor 2. The charged photoreceptor is then exposed to image wise light emitted from a light irradiating device (not shown) to form an electrostatic latent image on the photoreceptor 2. The electrostatic latent image is developed with the developer (i.e., toner) on the developing roller 103, resulting in formation of a toner image on the photoreceptor 2. The toner image is then transferred to a receiving material 7. The surface of the photoreceptor 2 is then cleaned by a cleaner 5 such as combinations of a brush and a blade. of a brush and a blade.

FIG. 2 illustrates the developer layer forming member 104 contacted with the surface of the developing roller 103. The developer layer forming member 104 is contacted with the developing roller 103. A point B denotes the center of the contact zone of the developer layer forming member 104 contacted with the developing roller 103. The contact zone is sometimes referred to as a nip. A point A is a point of a tip portion 104T of the developer layer forming member 104, and is 0.5 mm apart from the point B. A line LB is a tangent line to the developer layer forming member 104 at the point B, and a line LA is a tangent line to the developer layer forming member 104 at the point A. An angle α is an angle formed by the line LB and the line LA. Numeral 104E denotes an elementary portion of the developer layer forming member 104. The tip portion 104T of the developer layer forming member is preferably located on an upstream side from an elementary portion 104E thereof relative to a rotation direction of the developing roller 103.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Toner Preparation Examples 1-3 and Comparative Examples 1-10

### Preparation of First Binder Resin

The following components were contained in a dropping funnel.

Vinyl monomers

| | |
|---|---|
| Styrene | 600 g |
| Butyl acrylate | 110 g |
| Acrylic acid | 30 g |
| Dicumylperoxide | 30 g |
| (polymerization initiator) | |

The following components were contained in a four necked 5-liter flask equipped with a thermometer, a stainless stirrer, a condenser, and a nitrogen feed pipe.

Monomers for polyester resin

| | |
|---|---|
| Polyoxypropylene(2.2)-2,2-bis(4- | 1230 g |
| hydroxylphenyl)propane | |
| Polyoxyethylene(2.2)-2,2-bis(4- | 290 g |
| hydroxylphenyl)propane | |
| Isododecenyl succinic anhydride | 250 g |
| Terephthalic acid | 310 g |
| 1,2,4-benzenetricarboxylic acid anhydride | 180 g |
| Dibutyl tin oxide (esterification catalyst) | 7 g |
| Paraffin wax | 120 g |
| (melting point: 73.3° C., half | |
| width of absorption peak in | |
| DSC curve: 4° C., weight | |
| ratio of monomers to wax: 100:4) | |

The components in the four-necked flask were heated to 160° C. by a mantle heater while agitated with the stirrer under a nitrogen gas flow. In addition, the components in the dropping funnel was dropped in the flask over one hour. After the mixture was heated for 2 hours at 160° C. to complete an addition polymerization reaction, the reaction product was heated to 230° C. to perform a polycondensation reaction. The polymerization degree of the reaction product was occasionally checked by measuring the softening point of the reaction product using a constant-pressure orifice rheometer. When the reaction product had a desired softening point, the polycondensation reaction was stopped. Thus, a resin H1 having a softening point of 130° C. was prepared.

### Preparation of Second Binder Resin

The following components were contained in a four necked 5-liter flask equipped with a thermometer, a stainless stirrer, a condenser, and a nitrogen feed pipe.

Monomers for polyester resin

| | |
|---|---|
| Polyoxypropylene(2.2)-2,2-bis(4- | 2210 g |
| hydroxylphenyl)propane | |
| Terephthalic acid | 850 g |
| 1,2,4-benzenetricarboxylic acid anhydride | 120 g |
| Dibutyl tin oxide (esterification catalyst) | 0.5 g |

The components in the four-necked flask were heated to 230° C. by a mantle heater while agitated with the stirrer under a nitrogen gas follow to perform a polycondensation reaction. The polymerization degree of the reaction product was occasionally checked by measuring the softening point of the reaction product using a constant-pressure orifice rheometer. When the reaction product had a desired softening point, the polycondensation reaction was stopped. Thus, a resin L1 having a softening point of 115° C. was prepared.

### Preparation of Toner Particles

The following components were mixed with a HENSCHEL MIXER mixer.

| | |
|---|---|
| First binder resin (H1) | 60 parts |
| Second binder resin (L1) | 40 parts |
| C.I. Pigment Red 57-1 | 4 parts |
| (which is added in form | |
| of pigment master batch) | |

The mixture was then melted and kneaded with a cotyloid kneader. In this melting and kneading process, the temperature and pressure were changed to change the distribution of the wax in the kneaded mixture, i.e., to change the amount of wax present on the surface of the resultant toner particles (i.e., the amount of exposed wax).

The kneaded mixture was then cooled by a cooling press roller so as to have a thickness of 2 mm, followed by cooling with a cooling belt. After the cooled mixture was crushed with a feather mill, the particles were pulverized with a mechanical pulverizer KTM from Kawasaki Heavy Industries, Ltd. so as to have an average particle diameter of from 10 to 12 μm, followed by pulverization with a jet pulverizer IDS from Nippon Pneumatic Mfg. Co., Ltd. while being subjected to a coarse particle classification. The pulverized mixture was then subjected to a fine particle classification using a rotor classifier TURBOPLEX 100 ATP from Hosokawa Micron Corp. to prepare a colored particulate material (i.e., toner particles).

One hundred (100) parts of the thus prepared colored particulate material was mixed with 3.5 parts of a particulate silica CABOSIL TS530 from Cabot Corp. In this case, a HENSCHEL MIXER mixer (from Mitsui Miike Machinery Co., Ltd.) was used for mixing. Thus, magenta toners of Examples 1-3 and Comparative Examples 1-10 were prepared.

Each of the thus prepared magenta toners was evaluated as follows.

### 1. Amount of Exposed Wax

At first, 0.5 mg of the colored particulate material (i.e., toner particles) was weighed (this is hereinafter referred to as a toner I). On the other hand, 1.0 g of the colored particulate material was mixed with 7 ml of n-hexane, and the mixture was agitated for 1 minute using a roll mill which is rotated at a revolution of 120 rpm. The mixture was then subjected to suction filtering, and the colored particulate material treated with n-hexane was dried in vacuum to remove the solvent and moisture therefrom. Next, 0.5 mg of the thus treated colored particulate material was weighed (this is hereinafter referred to as a toner II).

The toners I and II were subjected to a differential scanning calorimetry (DSC) analysis using an instrument DSC6200 from Seiko Instruments Inc. In the DSC analysis, each of the toners I and II was heated to 200° C., followed by cooling to 0° C. Further, each of the toners was heated to 200° C. at a heating speed of 10° C./min to obtain the DSC curves of the toners. The contents of the wax in the toners I and II were determined by measuring the areas of the endothermic peaks (specific to the wax) of the respective DSC curves. Specifically, the exposed wax ratio (X) was determined by the following equation.

X(%)=100−100×(A_{TII})/(A_{TI})

wherein A_{TI} represents the area of the endothermic peak of the toner I, and A_{TII} represents the area of the endothermic peak of the toner II.

### 2. Particle Diameter Distribution and Average Particle Diameter

The particle diameter distribution, volume average particle diameter (Dv) and number average particle diameter (Dp) of a toner were determined using an instrument such as COULTER COUNTER TA-II or COULTER MULTISIZER II (from Beckman Coulter Inc.).

The measurement method is as follows:
(1) 0.1 to 5 ml of a surfactant serving as a dispersant (preferably an aqueous solution of an alkylbenzenesulfonic acid salt) is added to 100 to 150 ml of an electrolyte such as 1% aqueous solution of first class NaCl or ISOTON-II manufactured by Beckman Coulter, Inc.;
(2) 2 to 20 mg of a sample (i.e., a toner) to be measured is added into the mixture;
(3) the mixture is subjected to an ultrasonic dispersion treatment for about 1 to 3 minutes; and
(4) the volume average particle diameter distribution and number average particle diameter distribution of the toner are determined using the instrument mentioned above in which the aperture is 100 μm.

The weight average particle diameter and number average particle diameter of the toner can be determined from the thus obtained volume and number average particle diameter distributions.

In this case, the particle diameter channels are following 13 channels: 2.00 μm≦C1<2.52 μm; 2.52 μm≦C2<3.17 μm; 3.17 μm≦C3<4.00 μm; 4.00 μm≦C4<5.04 μm; 5.04 μm≦C5<6.35 μm; 6.35 μm≦C6<8.00 μm; 8.00 μm≦C7<10.08 μm; 10.08 μm≦C8<12.70 μm; 12.70 μm≦C9<16.00 μm; 16.00 μm≦C10<20.20 μm; 20.20 μm≦C11<25.40 μm; 25.40 μm≦C12<32.00 μm; and 32.00 μm≦C13<40.30 μm.

Thus, particles having a particle diameter not less than 2.00 μm and less than 40.30 μm are targeted.

### 3. Charge Quantity

Each of the toners and a carrier were mixed in a weight ratio of 5:95 to prepare two component developers. Each of the developers was allowed to settle for one hour at a predetermined temperature. The developer was agitated for 10 minutes at the temperature. The developer was then set in a measurement gauge having a 500-mesh screen, and the developer was subjected to a blow-off treatment for 30 seconds to determine the charge quantity Q/M (in units of μC/g) of the scattered powder (i.e., the toner).

### 4. Image Qualities

Each of the toner was set in a color laser printer, IPSIO CX2500 from Ricoh Co., Ltd. and a running test in which 5,000 copies of an original image are produced was performed. After the running test, the following image qualities were checked.

### (1) Toner Adhesion (Streak Image Caused by Toner Adhered to Developer Layer Forming Member)

After the running test, a solid image was produced. The solid image was visually observed to determine whether the image has a vertical white streak. The image was graded as follows from the viewpoint of white streak.
◯: The image has no white streak.
×: The image has one or more white streaks, and the image is not acceptable.

### (2) Background Development

After the running test, a white solid image was produced. The white solid image was visually observed to determine the whiteness of the background of the image, i.e., to determine whether the image is soiled with toner particles. The image was graded as follows from the viewpoint of background development.
◯: The background of the image is hardly soiled with toner particles.
×: The background of the image is soiled with toner particles, and the image is not acceptable.

### (3) Ghost Image

After the running test, a copy of an original image for use in evaluating ghost images was produced. The image was visually observed to determine whether the image has a ghost image. The image was graded as follows from the viewpoint of ghost image.
◯: The image has no ghost image.
×: The image has a ghost image, and the image is not acceptable.

### 5. Fixing Property (Separating Property)

At first, 5 parts by weight of each toner was mixed with 95 parts by weight of a carrier coated with a silicone resin were mixed to prepare two-component developers.

Each developer was set in an image forming apparatus (IPSIO CX7500 from Ricoh Co., Ltd.) to form an unfixed solid toner image, in which a white space with a length of 3 mm is formed at a tip portion of the solid image and which has a weight of 1.1±0.1 mg/cm², on each of sheets with A4 size of a receiving paper TYPE 6200 from Ricoh Co., Ltd. In this regard, the receiving paper is fed such that the longitudinal direction of the paper sheet is perpendicular to the paper feeding direction, and the machine direction of the paper (i.e., paper manufacturing direction) is perpendicular to the paper feeding direction.

Six (6) sheets of the paper sheets bearing the unfixed toner images were passed one by one through the fixing-belt type fixing device of an image forming apparatus (IPSIO CX2500 from Ricoh Co., Ltd.) while changing the temperature of the heat roller so as to be from 140 to 190° C. at intervals of 10° C., to determine the number of the paper sheets whose images were fixed without causing a paper jamming problem. In this regard, the fixing speed (i.e., the speed of the fixing belt) is 125 mm/sec. The fixing property of the toner was graded as follows.
◯: The number of the paper sheets whose images were fixed without causing a paper jamming problem is not less than 4.
×: The number of the paper sheets whose images were fixed without causing a paper jamming problem is less than 4.

The properties of the toners, the image forming conditions and the image qualities are shown in Tables 1 and 2.

TABLE 1

| | | | Volume | |
|---|---|---|---|---|
| | | | average | |
| | | Charge | particle | Content of |
| | Exposed wax | quantity | diameter | wax* |
| | ratio (%) | Q/M (-μC/g) | (Dv) (μm) | (parts) |
| Example 1 | 53.1 | 38.2 | 7.8 | 3.5 |
| Example 2 | 49.7 | 27.8 | 8.1 | 3.5 |
| Example 3 | 40.6 | 20.2 | 7.9 | 3.5 |
| Comp. Ex. 1 | 17.4 | 35.6 | 8.5 | 3.5 |
| Comp. Ex. 2 | 63.2 | 33.4 | 8.1 | 3.5 |
| Comp. Ex. 3 | 52.2 | 15.9 | 8.2 | 3.5 |
| Comp. Ex. 4 | 50.6 | 48.3 | 8.0 | 3.5 |
| Comp. Ex. 5 | 58.7 | 30.2 | 5.4 | 3.5 |
| Comp. Ex. 6 | 45.5 | 29.4 | 10.3 | 3.5 |
| Comp. Ex. 7 | 43.7 | 25.0 | 7.9 | 2.3 |
| Comp. Ex. 8 | 45.6 | 28.1 | 8.4 | 4.5 |
| Comp. Ex. 9 | 53.1 | 38.2 | 7.8 | 3.5 |
| Comp. Ex. 10 | 53.1 | 38.2 | 7.8 | 3.5 |

Content of wax*: The added amount of the wax (in units of parts) based on 100 parts by weight of the first binder resin

TABLE 2

| | Developer layer | | | | | |
|---|---|---|---|---|---|---|
| | forming | | Image qualities and fixing quality | | | |
| | condition | | | | | Fixing |
| | | Linear | | | | Property |
| | Angle α | pressure | | | | (separating |
| | (rad) | (N/m) | TA | BD | GI | property) |
| Ex. 1 | 0.349 | 50 | ◯ | ◯ | ◯ | ◯ |
| Ex. 2 | 0.873 | 50 | ◯ | ◯ | ◯ | ◯ |
| Ex. 3 | 1.571 | 50 | ◯ | ◯ | ◯ | ◯ |
| Comp. | 0.349 | 50 | ◯ | ◯ | ◯ | X |
| Ex. 1 | | | | | | |
| Comp. | 0.524 | 50 | X | ◯ | ◯ | ◯ |
| Ex. 2 | | | | | | |
| Comp. | 0.349 | 50 | ◯ | X | ◯ | ◯ |
| Ex. 3 | | | | | | |
| Comp. | 0.349 | 50 | ◯ | ◯ | X | ◯ |
| Ex. 4 | | | | | | |
| Comp. | 0.349 | 50 | X | ◯ | ◯ | ◯ |
| Ex. 5 | | | | | | |
| Comp. | 0.698 | 50 | ◯ | ◯ | ◯ | X |
| Ex. 6 | | | | | | |
| Comp. | 1.396 | 50 | ◯ | ◯ | ◯ | X |
| Ex. 7 | | | | | | |
| Comp. | 1.222 | 50 | X | ◯ | ◯ | ◯ |
| Ex. 8 | | | | | | |
| Comp. | 0.349 | 10 | ◯ | X | ◯ | ◯ |
| Ex. 9 | | | | | | |
| Comp. | 0.349 | 70 | X | ◯ | X | ◯ |
| Ex. 10 | | | | | | |

TA: Toner adhesion
BD: Background development
GI: Ghost image

It is clear from Tables 1 and 2 that by using the developing device and the image forming method of the present invention, high quality images can be produced without causing toner adhesion problem and fixing problem.

This document claims priority and contains subject matter related to Japanese Patent Application No. 2007-067649, filed on Mar. 15, 2007, incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent: of the United States is:

1. A developing device comprising:
a developing roller configured to bear a one component developer thereon to develop an electrostatic image; and
a developer layer forming member configured to form a layer of the one component developer on the surface of the developing roller, wherein the developer forming member is made of a metal,
wherein the one component developer includes a binder resin, a wax and a colorant, and the developing device satisfies the following relationships (1) and (2):
20<X<65−14α (1), and
12.7α−25>Q/M>13.1α−44.5 (2),
wherein X represents a ratio in units of % by weight of the wax present on a surface of the developer to a total of the wax included in the developer; α represents an angle formed by a first tangent line to the developer layer forming member at a point B, which is a center of a contact zone of the developer layer forming member contacted with the developing roller, and a second tangent line to the developer layer forming member at a point A thereof, which is 0.5 mm apart from the point B toward a tip of the developer layer forming member, wherein the angle α is from 0 to π/2 radian; and Q/M represents a charge quantity of the toner per unit weight and has units of μC/g.

2. The developing device according to claim 1, wherein the contact zone of the developer layer forming member is contacted with the developing roller at a linear pressure of from 20 N/m to 60 N/m.

3. The developing device according to claim 1, wherein the developer has a volume average particle diameter of from 6 μm to 10 μm.

4. The developing device according to claim 1, wherein the developer has a thermal property such that a maximum endothermic peak is observed in a temperature range of from 65° C. to 95° C. when the developer is subjected to differential scanning calorimetry in a temperature range of from 30° C. to 200° C.

5. The developing device according to claim 1, wherein the developer includes the wax in an amount of from 2.5% to 4.0% by weight based on a total weight of the developer.

6. The developing device according to claim 1, wherein the developer further includes an external additive in an amount of from 2.5% to 5.0% by weight based on a total weight of the developer.

7. The developing device according to claim 1, wherein the tip portion of the developer layer forming member is located on an upstream side from an elementary portion thereof relative to a rotation direction of the developing roller.

8. The developing device according to claim 1, further comprising:
a supplying roller configured to supply the developer to the developing roller, wherein the supplying roller is rotated in a same direction as a rotation direction of the developing roller.

9. A process cartridge comprising:
an image bearing member configured to bear an electrostatic image thereon; and
the developing device according to claim 1 configured to develop the electrostatic image to form a toner image on the image bearing member,
wherein the process cartridge is detachably attached to an image forming apparatus as a unit.

10. An image forming method comprising:
forming a layer of a one component developer on a developing roller using a developer layer forming member; and
developing an electrostatic image on an image bearing member with the developer layer on the developing roller,
wherein the one component developer includes a binder resin, a wax and a colorant, and the following relationships (1) and (2) are satisfied:
20<X<65−14α (1), and
12.7α−25>Q/M>13.1α−44.5 (2),
wherein X represents a ratio in units of % by weight of the wax present on a surface of the developer to a total of the wax included in the developer; a represents an angle formed by a first tangent line to the developer layer forming member at a point B, which is a center of a contact zone of the developer layer forming member contacted with the developing roller, and a second tangent line to the developer layer forming member at a point A thereof, which is a point of a tip portion of the developer layer forming member and is 0.5 mm apart from the point B, wherein the angle α is from 0 to π/2 radian; and Q/M represents a charge quantity of the toner per unit weight and has units of μC/g.
